(19) United States
(12) Patent Application Publication
(10) Pub. No.: US 2004/0191694 A1
(43) Pub. Date: Sep. 30, 2004

(54) Process for prepaing light-sensitive lithographic printing plate and method for processing the same

(76) Inventors: Hideo Kiyoyama, Tokyo (JP); Yutaka Araki, Tokyo (JP); Takashi Miyazaki, Tokyo (JP); Akira Furukawa, Tokyo (JP)

Correspondence Address: BIRCH STEWART KOLASCH & BIRCH, PO BOX 747, FALLS CHURCH, VA, 22040-0747, US

(21) Appl. No.: 10/811,804

(22) Filed: Mar. 30, 2004

(30) Foreign Application Priority Data
Mar. 31, 2003 (JP) 2003-093293

(51) Int. Cl. G03C 1/76

(52) U.S. Cl. 430/302

(57) ABSTRACT

There is disclosed a process for preparing a light-sensitive lithographic printing plate using an aluminum plate as a support, which comprises subjecting the aluminum support after anodization treatment to a treatment in an alkali silicate with a concentration of SiO₂ of 1 to 4% by weight, a concentration of an alkali metal hydroxide of 0.5 to 5% by weight and a molar ratio of SiO₂/M₂O where M represents an alkali metal being in the range of 0.3 to 1.5 at 50 to 70° C. for 20 seconds or shorter.

### BACKGROUND OF THE INVENTION

1. Field of the Invention

This invention relates to a process for preparing a light-sensitive lithographic printing plate using an aluminum plate as a support and a method for processing the same.

2. Prior Art

A widely used type of lithographic printing plate has a light-sensitive coating film coated on an aluminum support. This coating film cures by exposure to light and the portion not exposed is dissolved by a developing treatment. This type of a plate is called to as a negative type printing plate. A lithographic printing plate utilizes surface properties of a pattern formed on the surface of the lithographic printing plate and a background portion having lipophilic property and hydrophilic property, respectively. When conducting lithographic printing, ink and damping water are simultaneously applied onto the printing surface of a printing press, and the ink is selectively transferred onto the pattern having lipophilic property. The ink transferred onto the pattern is then transferred to an intermediate material called to as a blanket and further transferred to a printing paper whereby printing is carried out.

Many researches have been conventionally done about light-sensitive composition for forming a relief image utilizing change in solubility by the photoreaction as mentioned above, and practically applicable materials have been provided. For example, in Japanese Patent Publications No. 34041/1974 and No. 105353/1994 and U.S. Pat. No. 5,153,095, etc., a light-sensitive composition mainly comprising a polymer having an ethylenically unsaturated bond at the side chain, a cross-linking agent and a photopolymerization initiator has been disclosed. Such a composition has a light-sensitive property to light having a short wavelength mainly at a ultraviolet rays region of 400 nm or shorter.

On the other hand, in recent years, it has been desired to develop a light-sensitive material having high sensitivity to visible rays accompanying with the progress of image forming techniques. For example, researches have been actively carried out on a light-sensitive material and a light-sensitive lithographic printing plate corresponding to an output machine using argon laser, helium-neon laser, red-color LED, etc.

Moreover, accompanying with the marked progress in semi-conductor laser, a near infrared laser light source having 700 nm to 1300 nm can be easily used whereby a light-sensitive material and a light-sensitive lithographic printing plate corresponding to said laser light has attracted attention.

As a photopolymerizable composition having a light-sensitive property at the above-mentioned visible rays to near infrared rays, there are disclosed a lithographic printing plate containing a radical polymerizable compound having an ethylenically unsaturated bond, a photosensitizing dye having an absorption peak at 400 to 500 nm and a polymerization initiator in Japanese Provisional Patent Publication No. 134007/1997; a combination of an organic boron anion and a dye in Japanese Provisional Patent Publication No. 2000-98603; a combination of a dye and an s-triazine compound in Japanese Provisional Patent Publication No. 43633/1994; and a combination of a resol resin, a novolac resin, an infrared rays absorber and a photo-acid generator in Japanese Provisional Patent Publication No. 20629/1995.

Characteristics of the lithographic printing plates obtained by the above-mentioned methods are markedly influenced by a light-sensitive layer to be used, adhesiveness thereof to an aluminum support and hydrophilic property (oil-repellent property) of the aluminum support. That is, the adhesiveness greatly pertains to printing endurance, and the hydrophilicity to stain-resistance at a non-image portion.

Accordingly, to improve characteristics of the lithographic printing plate, it has been known to carry out a hydrophilicity-imparting treatment such as a silicate treatment to the surface of an aluminum support for a lithographic printing plate after anodization treatment. For example, there may be mentioned a method of forming a silicate film on a support after hot water treatment by immersing in a silicate solution (Japanese Provisional Patent Publication No. Hei.10-244637, pages 2-4), or a method of introducing a silicone compound after the silicate treatment (Japanese Provisional Patent Publication No. Hei.10-97056, page 3). When such a hydrophilicity-imparting treatment is applied to the surface of an aluminum support for a lithographic printing plate, ink is difficultly adhered to a non-image portion of the lithographic printing plate which is hydrophobic at the time of printing and stain-resistance is improved. However, when the hydrophilicity-imparting treatment-is applied to the surface of an aluminum support for a lithographic printing plate, adhesiveness between a light-sensitive layer which is hydrophobic in a raw plate of the lithographic printing plate and the aluminum support, so that a problem arises that printing endurance is lowered when the plate is used as a lithographic printing plate.

### SUMMARY OF THE INVENTION

An object of the present invention is to provide a process for preparing a light-sensitive lithographic printing plate using an aluminum plate as a support by applying a hydrophilicity-imparting treatment whereby stain-resistance is improved and further printing endurance is also excellent, and to provide a method for processing the light-sensitive lithographic printing plate obtained by the same.

The present inventors have studied intensively to accomplish the above-mentioned objects, and as a result, they have found a process for preparing a light-sensitive lithographic printing plate using an aluminum plate as a support, which comprises subjecting the aluminum support after anodization treatment to a treatment in an alkali silicate with a concentration of SiO₂ of 1 to 4% by weight, a concentration of an alkali metal hydroxide of 0.5 to 5% by weight and a molar ratio of SiO₂/M₂O where M represents an alkali metal being in the range of 0.3 to 1.5 at 50 to 70° C. for 20 seconds or shorter.

Moreover, a method for processing the light-sensitive lithographic printing plate of the present invention comprises subjecting the above-mentioned lithographic printing plate after image exposure to development with an aqueous developer having a pH of 10 to 12.

### BRIEF DESCRIPTION OF THE DRAWING

FIG. 1 is a scanning type electron microscopic photograph in which a surface state of the aluminum support obtained in the present invention 5 of Example 1 was photographed.

### DESCRIPTION OF THE PREFERRED EMBODIMENTS

In the following, the embodiments of the present invention are explained in detail.

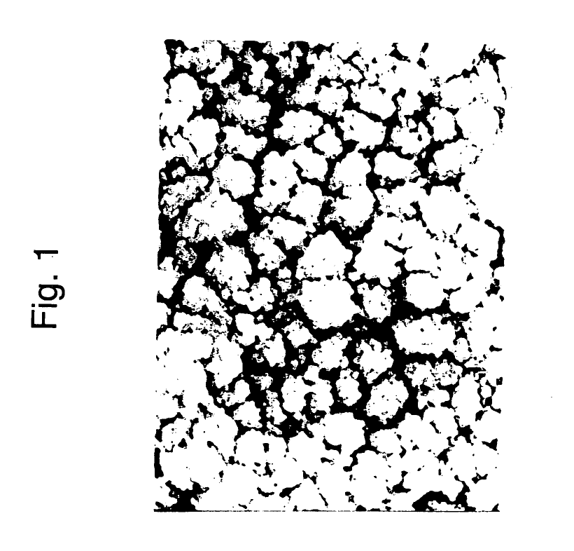

According to the light-sensitive lithographic printing plate of the present invention, printing endurance can be improved while improving stain resistance at the non-image portion. In the process of the present invention, it can be found that an aluminum support is immersed in a solution having the above-mentioned composition, fine structure can be formed (see FIG. 1) on the surface of the support while forming a film of a silicate, which is different from the conventional method for forming a silicate film. By forming the fine structure, printing endurance of an image portion can be improved and further printing stain at a non-image portion can be prevented by the formation of the silicate film. Moreover, as shown in Examples mentioned below, it can be found that printing endurance can be more improved by treating the printing plate with a developer preferably having a pH of 10 to 12. To the light-sensitive lithographic printing plate of the present invention, a hydrophilic treatment has been applied, so that it is excellent in stain resistance in addition to excellent printing endurance. The light-sensitive lithographic printing plate of the present invention can be suitably used for preparing a raw plate of a thermal negative-type lithographic printing plate.

The aluminum plate to be used as a support of the light-sensitive lithographic printing plate of the present invention comprises a metal mainly containing aluminum which is dimensionally stable and comprises aluminum or an aluminum alloy.

In the following explanation, various kinds of substrates comprising aluminum or an aluminum alloy mentioned above are called to as an aluminum plate. As a hetero element to be contained in the above-mentioned aluminum alloy, there may be mentioned silicon, iron, manganese, copper, magnesium, chromium, zinc, bismuth, nickel, titanium and the like, and the content of the hetero element in the aluminum alloy is 10% by weight or less. A content of copper is particularly preferably 0 to 0.05% by weight.

In the present invention, it is suitable to use a pure aluminum plate but it is difficult to produce a completely pure aluminum plate in view of the refining technology so that a small amount of the hetero element may be contained. As mentioned above, the aluminum plate to be used in the present invention is not specifically limited in the composition, and conventionally well known and widely been used materials including aluminum alloy plates such as JIS A1050, JIS A1100, JIS A3005, JIS A3004, International Registration Alloy 3103A and the like may be optionally employed. A method for producing the aluminum plate may be either of the continuous casting system or of the DC casting system, and an aluminum plate in which an intermediate annealing or uniform heating treatment in the DC casting system is omitted may be used. Also, an aluminum plate to which unevenness is applied by a laminating rolling or transfer, etc. at the final rolling may be used. A thickness of the aluminum plate to be used in the present invention is about 0.1 mm to about 0.6 mm. The thickness may be optionally changed according to a size of a printing machine, a size of a lithographic printing plate, or a request by a user.

The aluminum support for the lithographic printing plate of the present invention can be obtained by subjecting an anodization treatment and hydrophilic treatment to the above-mentioned aluminum plate. In the preparation process of the aluminum support, various steps other than the above anodization treatment and hydrophilic treatment may be contained.

The above aluminum plate is usually subjected to a sand grinding treatment to obtain a more preferred shape. As the sand grinding treatment, there may be used a mechanical sand grinding (a mechanical surface roughening treatment) as disclosed in Japanese Provisional Patent Publication No. Sho.56-28893, a chemical etching, an electrolysis grain, etc. Moreover, there may be used an electrochemical sand grinding method (an electrochemical surface roughening treatment, an electrolysis surface roughening treatment) in which a material is electrochemically sand grinded in a hydrochloric acid electrolytic solution or nitric acid electrolytic solution, and a mechanical sand grinding method (a mechanical surface roughening treatment) such as a wire brush grain method in which an aluminum surface is scratched with metallic wire, a ball grain method in which an aluminum surface is sand grinded with ground balls and a grinding agent, a brush grain method in which a surface is sand grinded with a Nylon brush and a grinding agent, etc. These sand grinding methods can be used singly or in combination. For example, there may be mentioned a combination of a mechanical surface roughening treatment by a Nylon brush and a grinding agent, and an electrolysis surface roughening treatment using a nitric acid electrolytic solution or a combination of a plural number of the electrolysis surface roughening treatments.

In the brush grain method, an average depth at the concave portions to the direction of a long wavelength component of the surface of the aluminum support can be controlled by optionally selecting respective conditions such as an average grain diameter and a maximum grain size of the particles to be used as a grinding agent, hair diameter, hair density and a pressure of the brush to be pressed, etc. The concave portions obtained by the brush grain method preferably have an average wavelength of 3 to 15 μm and an average depth of 0.3 to 1 μm.

The electrochemical surface roughening method preferably includes an electrochemical method in which sand grinding is carried out chemically in a hydrochloric acid electrolytic solution or nitric acid electrolytic solution. A current density thereof is preferably an electric amount at an anode of 50 to 400 C./dm². More specifically, it is preferably carried out in an electrolyte containing 0.1 to 50% by weight of hydrochloric acid or nitric acid at a temperature of 20 to 100° C. for 1 second to 30 minutes with a current density of 100 to 400 C./dm² with the use of a direct current or an alternating current. According to the electrolytic surface roughening treatment, it is easy to provide fine unevenness to the surface, so that it is suitable to improve adhesiveness between the light-sensitive layer and the aluminum support.

According to the electrochemical surface roughening treatment after the mechanical surface roughening treatment, crater or honeycomb shaped pits with an average diameter of 0.3 to 1.5 μm and an average depth of 0.05 to 0.4 μm can be formed on the surface of the aluminum plate with a surface areal ratio of 80 to 100%. When the electrochemical surface roughening treatment alone is carried out without carrying out the mechanical surface roughening treatment, it is preferred to make an average depth of the pits less than 0.3 μm. The pits provided have functions of preventing stain at the non-image portion of a printing plate and improving printing endurance. In the electrolytic surface roughening treatment, an electric amount necessary for providing a sufficient amount of pits to the surface, i.e. the product of a current and a time during which the current turns on is an important condition. It is preferred to form a sufficient amount of pits with a less amount of electricity in the point of saving energy. A surface roughness after the roughening treatment preferably has a mathematical average roughness (Ra) of 0.2 to 0.5 μm measured by a cutoff value of 0.8 mm and an evaluation length of 3.0 mm according to JIS B0601-1994.

To the aluminum plate thus subjected to the sand grinding treatment, a chemical etching treatment is further preferably carried out. As the chemical etching treatment, it has been known an etching with an acid or an etching with an alkali, and a chemical etching treatment using an alkali solution may be mentioned as a method which is particularly excellent in the point of etching efficiency.

The alkali agent to be suitably used in the present invention is not specifically limited, and there may be mentioned, for example, sodium hydroxide, sodium carbonate, sodium aluminate, sodium metasilicate, sodium phosphate, potassium hydroxide and lithium hydroxide. The conditions for the alkali etching treatment are so set that a dissolved amount of Al is 0.05 to 1.0 g/m². The other conditions are not specifically limited, and a concentration of the alkali is preferably 1 to 50% by weight, more preferably 5 to 30% by weight, and a temperature of the alkali is preferably 20 to 100° C., more preferably 30 to 50° C. The alkali etching treatment is not limited only by one method and a plural number of steps may be combined. In the present invention, the alkali etching treatment may be carried out after the mechanical surface roughening treatment and before the electrochemical surface roughening treatment. In this case, a dissolved amount of Al is preferably set to 0.05 to 30 g/m².

After subjecting to the alkali etching treatment, washing with an acid is carried out to remove stain (or smut) remained at the surface. As the acid to be used, there may be mentioned nitric acid, sulfuric acid, phosphoric acid, chromic acid, hydrofluoric acid and borofluoric acid. As the smut removing treatment method after the electrolysis surface roughening treatment, a method of contacting with sulfuric acid with a concentration of 15 to 65% by weight at a temperature of 50 to 90° C. is preferably mentioned as disclosed in Japanese Provisional Patent Publication No. Sho.53-12739.

When the chemical etching treatment is carried out with an acidic solution, the acid to be used for the acidic solution is not specifically limited, and, for example, sulfuric acid, nitric acid, hydrochloric acid, etc. are mentioned. A concentration of the acid solution is preferably 1 to 50% by weight. Also, a temperature of the acid solution is preferably 20 to 80° C.

To the thus treated aluminum plate as mentioned above, an anodization treatment is further carried out. The anodization treatment can be carried out with a method that has conventionally been carried out in this field of the art. More specifically, an anodized film can be formed on the surface of the aluminum plate when a direct current or an alternating current is passed through the aluminum plate in an aqueous or non-aqueous solution containing at least one of sulfuric acid, phosphoric acid, chromic acid, oxalic acid, sulfamic acid, benzenesulfonic acid, etc.

At this time, at least one of the components usually contained in the Al alloy plate, an electrode, tap water, subterranean water, etc. may be contained in the electrolyte. Moreover, the second and the third components may be added to the electrolyte. The second and the third components herein mentioned may include, for example, an ion of a metal such as Na, K. Mg, Li, Ca, Ti, Al, V, Cr, Mn, Fe, Co, Ni, Cu, Zn, etc.; a cation such as an ammonium ion; an anion such as a nitrate ion, a carbonate ion, a chloride ion, a phosphate ion, a fluoride ion, a sulfite ion, a titanate ion, a silicate ion, a borate ion, etc., with a concentration of 0 to about 1000 ppm in the electrolyte.

The conditions of the anodization treatment may vary depending on the electrolyte to be used and cannot be solely determined. The conditions are generally an electrolyte concentration of 1 to 80% by weight, a liquid temperature of −5 to 70° C., a current density of 0.5 to 60 A/dm², a voltage of 1 to 100 V and an electrolysis time of 10 to 200 seconds. Of these anodization treatment, it is particularly preferred to carry out the anodization treatment under high current density in a sulfuric acid electrolyte as disclosed in GB Patent No. 1,412,768.

In the present invention, an amount of the anodized film is preferably 1 to 10 g/m². If it is less than 1 g/m², scratch or flaw is likely generated on the plate, while if it exceeds 10 g/m², a great amount of electric power is required for production so that it is economically disadvantageous. An amount of the anodized film is more preferably 1.5 to 7 g/m², particularly preferably 2 to 5 g/m². After the surface roughening treatment, an alkali etching treatment may be carried out before the electrochemical surface roughening treatment. In this case, an amount of Al to be dissolved is preferably set to 0.05 to 30 g/m².

In a liquid to treat the aluminum support to be used in the present invention after anodization, there exists a preferred range in the respective components to be contained in the liquid. That is, it is essential to contain SiO₂ in an alkali metal silicate of 1 to 4% by weight, an alkali metal hydroxide of 0.5 to 5% by weight and a molar ratio of SiO₂/M₂O (wherein M represents an alkali metal) in the range of 0.3 to 1.5.

The above-mentioned treating liquid has a liquid pH of 13.1 to 13.3 as a result, so that it has a higher pH region than the pH (10 to 13) of the treating liquid for silicate treatment conventionally well known in the art. The aluminum support is subjected to treatment by using the above-mentioned treating liquid, fine projected structure is formed on the surface in addition to the silicate treatment which is different from the usual silicate treatment. According to this procedure, while maintaining an adhesiveness between the light-sensitive layer and the surface of the aluminum support, a hydrophilic property of the non-image portion can be improved (see FIG. 1).

When an amount of the alkali metal hydroxide is too much or an amount of SiO₂ is too little, fine projected structure is formed excessively, so that adhesion to an image portion is strong and printing endurance is improved but dissolution at a non-image portion becomes poor. On the other hand, when an amount of the alkali metal hydroxide is too little or an amount of SiO₂ is too much, the non-image portion is difficultly stained but printing endurance at the image portion becomes poor.

The alkali metal silicate of the present invention is at least one of the compounds selected from the group consisting of sodium silicate, potassium silicate and lithium silicate, and the alkali metal hydroxide is at least one of the compounds selected from the group consisting of sodium hydroxide, potassium hydroxide and lithium hydroxide, each of which may be used singly or in combination of two or more. If the contents thereof are those other than the above-mentioned ranges, for example, when the alkali metal hydroxide is added in excess of the above-mentioned range, the projects formed on the surface become too large or are excessively formed, so that it causes background stain. On the other hand, when the alkali metal silicate is added in excess of the above-mentioned range, silicate treatment is progressed on the surface of the support but fine projects are not formed on the surface of the support, so that adhesiveness between an image portion and the aluminum support is poor and printing endurance at the time of printing is also poor, which are not preferred. With regard to the alkali metal ion, any of the ions may be used since all of them have fine project-forming effect and silicate-treated surface-forming effect. Of these, a treating liquid containing a potassium ion is particularly preferably used since formation of fine project structure is excellent.

When the treatment is carried out by using the treating liquid of the present invention, there exist preferred ranges in conditions. A treatment temperature is in the range of 50 to 70° C., preferably in the range of 55 to 65° C., and a treatment time is 20 seconds or shorter, preferably 0.5 to 20 seconds, more preferably 1 to 10 seconds. When the treatment is carried out at a temperature higher than the above range, fine projects are excessively formed on the surface, so that it causes background stain as in the case where the alkali metal hydroxide is excessively used. On the other hand, when the treatment is carried out at a temperature lower than the above range, formation of the fine products is a little, so that printing endurance at the time of printing becomes poor.

A method of washing in the present invention is not specifically limited, and may be carried out by a spraying method, an immersing method, and the like. These methods may be carried out singly with one time or a plural number of times, or may be carried out in combination of two or more kinds of methods. A treatment time of washing is not specifically limited.

For preparing a raw plate of the lithographic printing plate using the above-mentioned aluminum support of the present invention, a light-sensitive material is coated on the surface of the support and dried to form a light-sensitive layer thereon. The light-sensitive material is not specifically limited, and those used in the conventional light-sensitive lithographic printing plate may be used. There may be mentioned, for example, a conventional positive type light-sensitive layer containing a novolac resin and naphthoquinonediazide. The lithographic printing plate obtained by forming the light-sensitive layer is then further treated by subjecting to image-printing by using a lithographic film, development and finishing treatment, whereby a lithographic printing plate which can be attached to a printing machine can be prepared.

Also, when a light-sensitive layer having a sensitivity to laser light, an image can be directly printed on the layer by using laser light. For example, there may be mentioned a thermal positive type light-sensitive layer and a thermal negative type light-sensitive layer. Of these, a thermal negative type one is particularly preferably used for a printing plate since an image is cross-linked at the time of exposure. The aluminum support of the present invention preferably has a light-sensitive layer which is a photopolymerizable layer_containing at least a polymer which contains a monomer having a polymerizable double bond and a carboxyl group as a copolymerizable component, and an organic borate. Such a light-sensitive layer causes a cross-linking reaction by a photo-energy of laser light to form an image. When the light-sensitive layer is used, it has been known that it is not necessary to carry out pre-heating after exposure and resistance to air oxidation is good as a thermal negative type printing plate. However, when a silicate treatment which has conventionally been well known is carried out to such a thermal negative type printing plate, there is a problem that an adhesiveness between the aluminum support and an image portion becomes extremely poor. This problem can be solved by the present invention by carrying out a surface treatment of the aluminum support under the conditions of the present invention to form a fine project structure on the surface. According to the surface treatment, a problem inherent in a printing plate in which the silicate treatment is not provisionally carried out, for which a silicate must be contained in a developer, can be solved. In the following, the light-sensitive layer which is a photopolymerizable layer containing at least a polymer which contains a monomer having a polymerizable double bond and a carboxyl group as a copolymerizable component, and an organic borate is explained in detail.

As a photoradical generator to be used in the present invention, there may be mentioned an aromatic ketone, an aromatic onium salt compound, an organic peroxide, a hexaarylbiimidazole compound, a ketoxime ester compound, an azinium compound, an active ester compound, a trihaloalkyl-substituted compound and an organic boron salt. Of these, most preferably used is the organic boron salt and an organic boron anion constituting the organic boron salt is represented by the following formula (I):

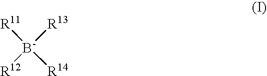

wherein R¹¹, R¹², R¹³ and R¹⁴ may be the same or different from each other, and each independently represents an alkyl group, an aryl group, an aralkyl group, an alkenyl group, an alkynyl group, a cycloalkyl group or a heterocyclic group. Of these, particularly preferred is that one of R¹¹, R¹², R¹³ and R¹⁴ represents an alkyl group and other three are aryl groups.

The above organic boron anion coexists with a cation which forms a salt therewith. As the cation in this case, there may be mentioned an alkali metal ion, an onium ion and a cationic sensitizing dye. As the onium ion, there may be mentioned an ammonium ion, a sulfonium ion, an iodonium ion and a phosphonium ion. When a salt of the alkali metal ion or the onium ion and the organic boron anion is used, if a sensitizing dye is separately added thereto, sensitivity at a wavelength region at which the dye absorbs light can be imparted. Also, when the organic boron anion is contained as a pair anion of the cationic sensitizing dye, sensitivity is imparted depending on an absorption wavelength of the sensitizing dye. In the latter case, it is preferred to use the organic boron anion as a pair anion of the alkali metal or the onium salt in combination.

As the organic boron salt to be used in the present invention, it is a salt containing the organic boron anion represented by the above-mentioned formula (I), and as the cation to form a salt, an alkali metal ion and an onium compound is preferably used. Particularly preferred examples of the onium salt with the organic boron anion is an ammonium salt such as tetraalkylammonium salt, etc., a sulfonium salt such as triarylsulfonium salt, etc., a phosphonium salt such as a triarylalkylphosphonium salt, etc. Particularly preferred examples of the organic boron salt are mentioned below.

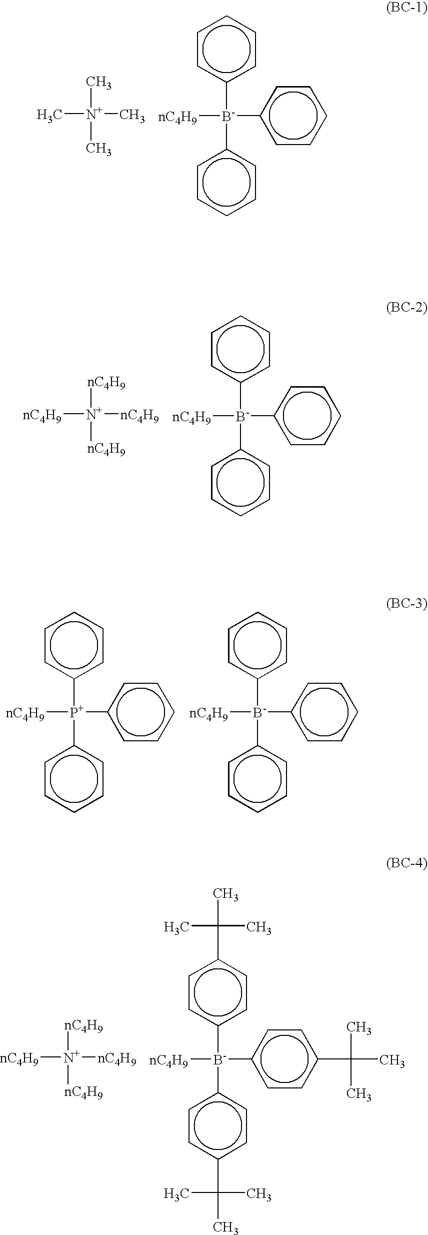

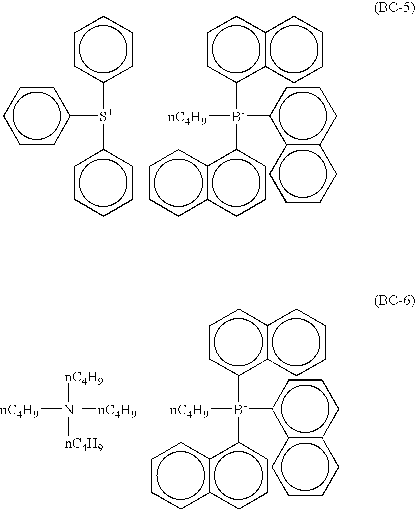

A content of the above-mentioned photoradical generator is preferably 1 to 100 parts by weight, more preferably 1 to 40 parts by weight based on 100 parts by weight of the binder.

As a preferred embodiment of the present invention, the organic boron compound is used in combination with a trihaloalkyl-substituted compound as photoradical generators in the light-sensitive lithographic printing plate material. By using the trihaloalkyl-substituted compound in combination, preservability of the light-sensitive lithographic printing plate is good. The trihaloalkyl-substituted compound herein mentioned means a compound having at least one trihaloalkyl group such as a trichloromethyl group and a tribromomethyl group in the molecule. Preferred examples thereof may include an s-triazine derivative and an oxadiazole derivative in which said trihaloalkyl group binds to the nitrogen-containing heterocyclic group, or a trihaloalkylsulfonyl compound in which said trihaloalkyl group binds to an aromatic ring or a nitrogen-containing heterocyclic ring through a sulfonyl group.

Particularly preferred examples of the nitrogen-containing heterocyclic ring compound substituted by the trihaloalkyl group (T-1 to T-15) or the triahloalkylsulfonyl compound (BS-1 to BS-10) are mentioned below:

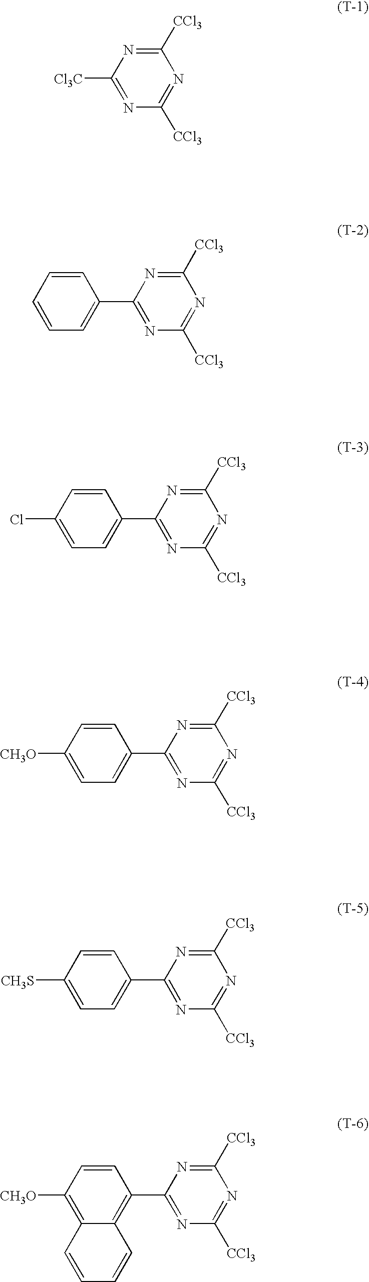

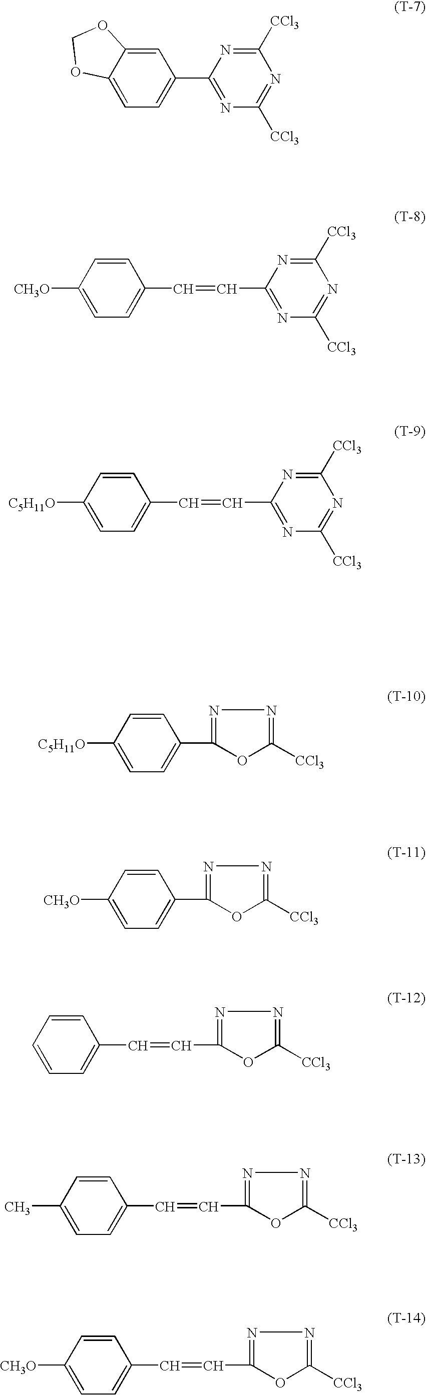

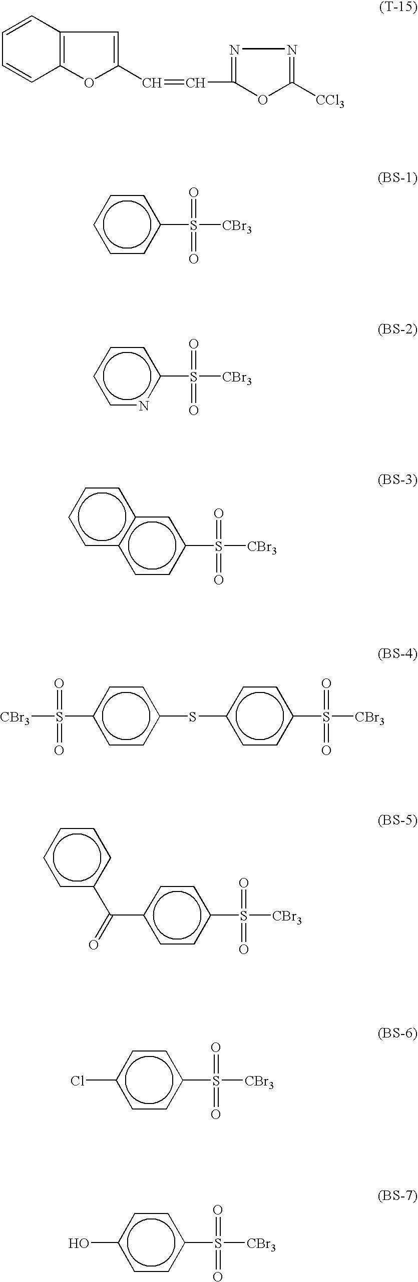

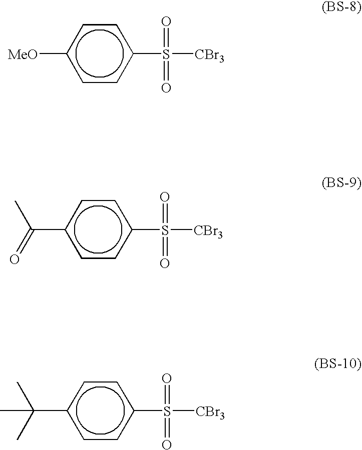

A content of the above-mentioned nitrogen-containing heterocylcic ring compound substituted by the trihaloalkyl group or the trihaloalkylsulfonyl compound is preferably 1 to 100 pars by weight, more preferably 1 to 40 parts by weight based on 100 parts by weight of the binder.

As a preferred embodiment of the present invention, the organic boron salt is preferably used in combination with a dye which sensitizes the salt in the light-sensitive lithographic printing plate material. The organic boron salt used at this time is a salt which does not show any sensitivity at the wavelength region from the visible light to the infrared light and firstly shows sensitivity to the light with such a wavelength region by the addition of the sensitizing dye.

The light-sensitive composition of the present invention preferably contains a sensitizer which has an absorption at a wavelength region from the visible light to the infrared light and can sensitizes the above-mentioned photoradical generator so that the composition can correspond to various light sources from the visible light to infrared light. As the sensitizing agent, various kinds of sensitizing dyes can be preferably used. Such sensitizers may include cyanine, phthalocyanine, merocyanine, coumarin, porphyrin, a spiro compound, ferrocene, fluorene, fulgide, imidazole, perylene, phenazine, phenothiazine, polyene, an azo compound, diphenylmethane, triphenylmethane, polymethyne acridine, ketocoumarin, quinacridone, indigo, styryl, a squarylium compound, a pyrilium compound, a thiopyrilium compound, etc., and further, compounds disclosed in EP 0 568 993 B, U.S. Pat No. 4,508,811 and No. 5,227,227 may be used.

Specific examples of the sensitizing dye having an absorption at visible light region (360 to 700 nm) are mentioned below, but the present invention is not limited by them.

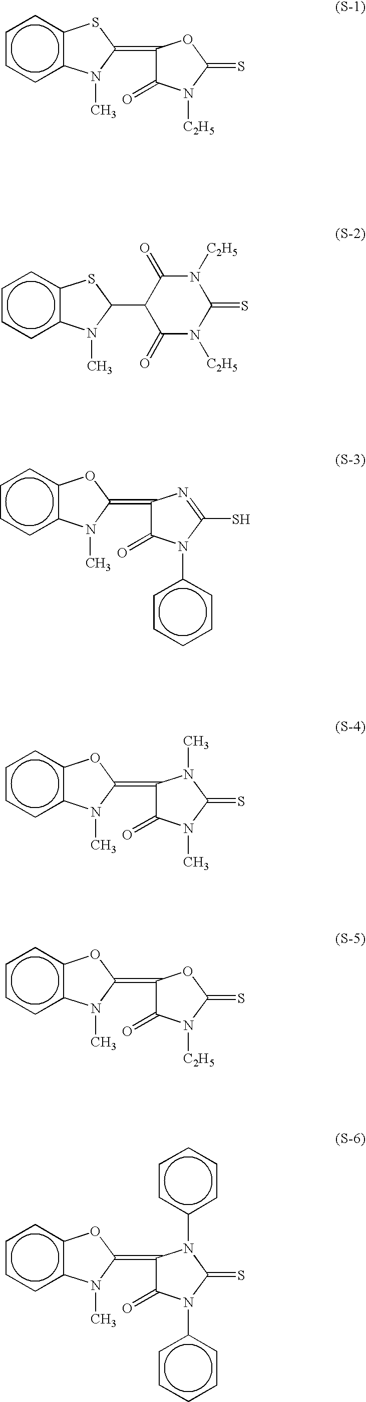

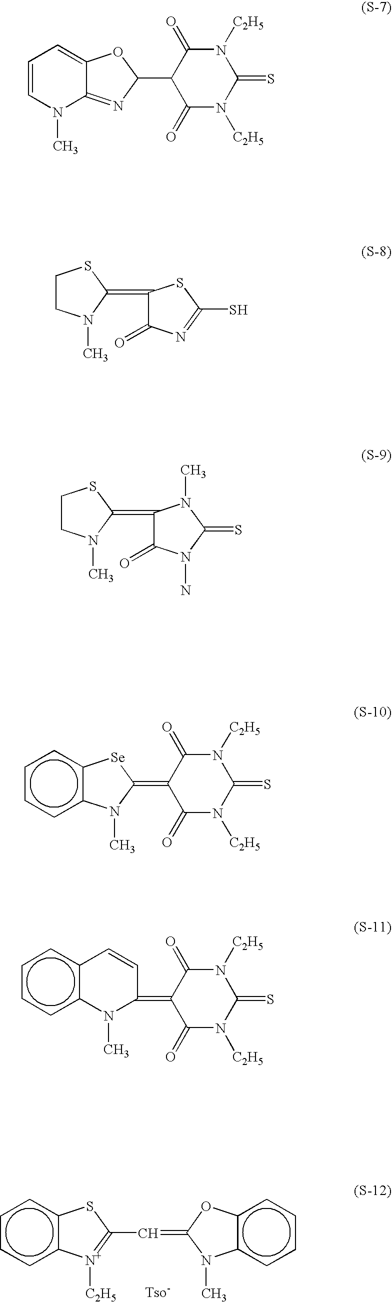

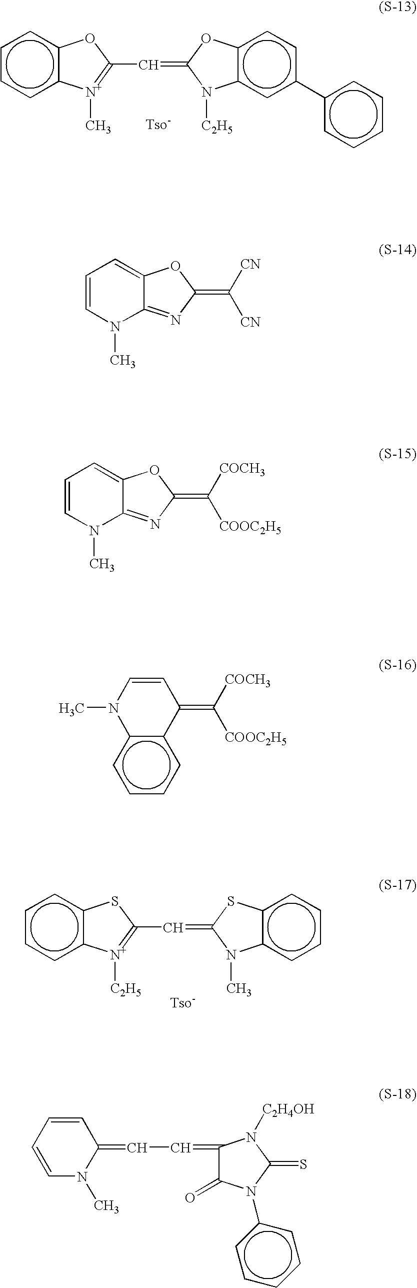

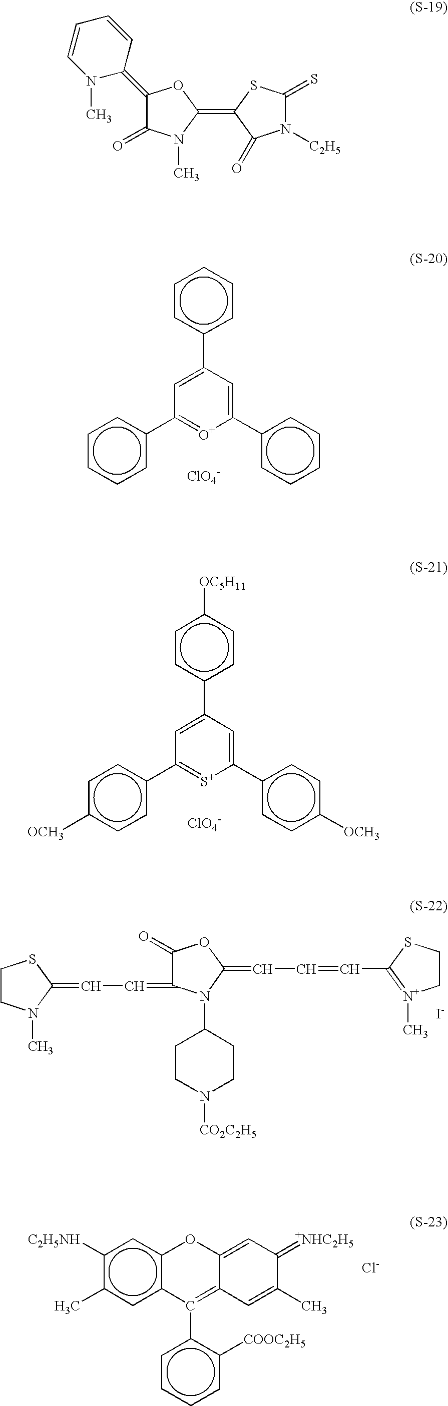

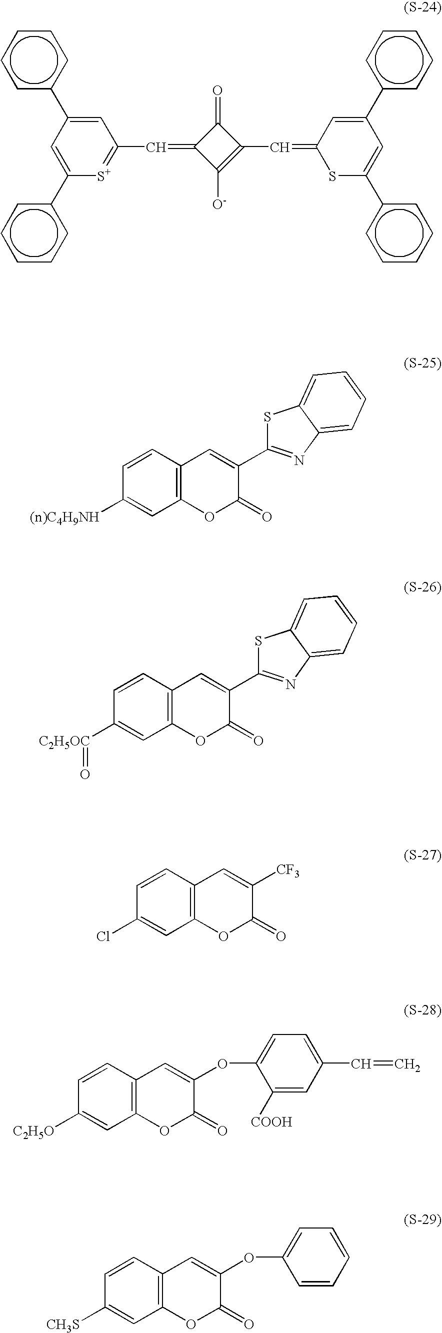

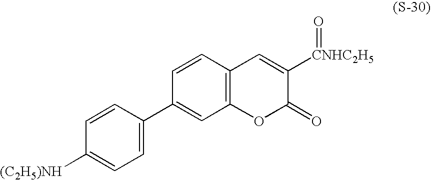

In recent years, an output machine mounted thereon a violet laser diode having an oscillation wavelength of 360 to 430 nm has been developed. This output machine has the maximum exposure energy dose of several tens μJ/cm² or so and a light-sensitive material to be used is required to have high sensitivity. In the present invention, it can be realized to use the lithographic printing plate of the present invention in this output machine by using the above-mentioned sensitizing dye in combination. Among the above-mentioned sensitizing dyes, the pyrilium compound or the thiopyrilium compound is preferred for the violet laser diode.

Also, the lithographic printing plate of the present invention can be extremely suitably used for light with near infrared rays to infrared rays, i.e., 700 nm or longer, further for scanning exposure using laser light with wavelength region of 750 to 1100 nm. Specific examples of sensitizing dyes to be used for sensitizing the composition to near infrared rays are shown below.

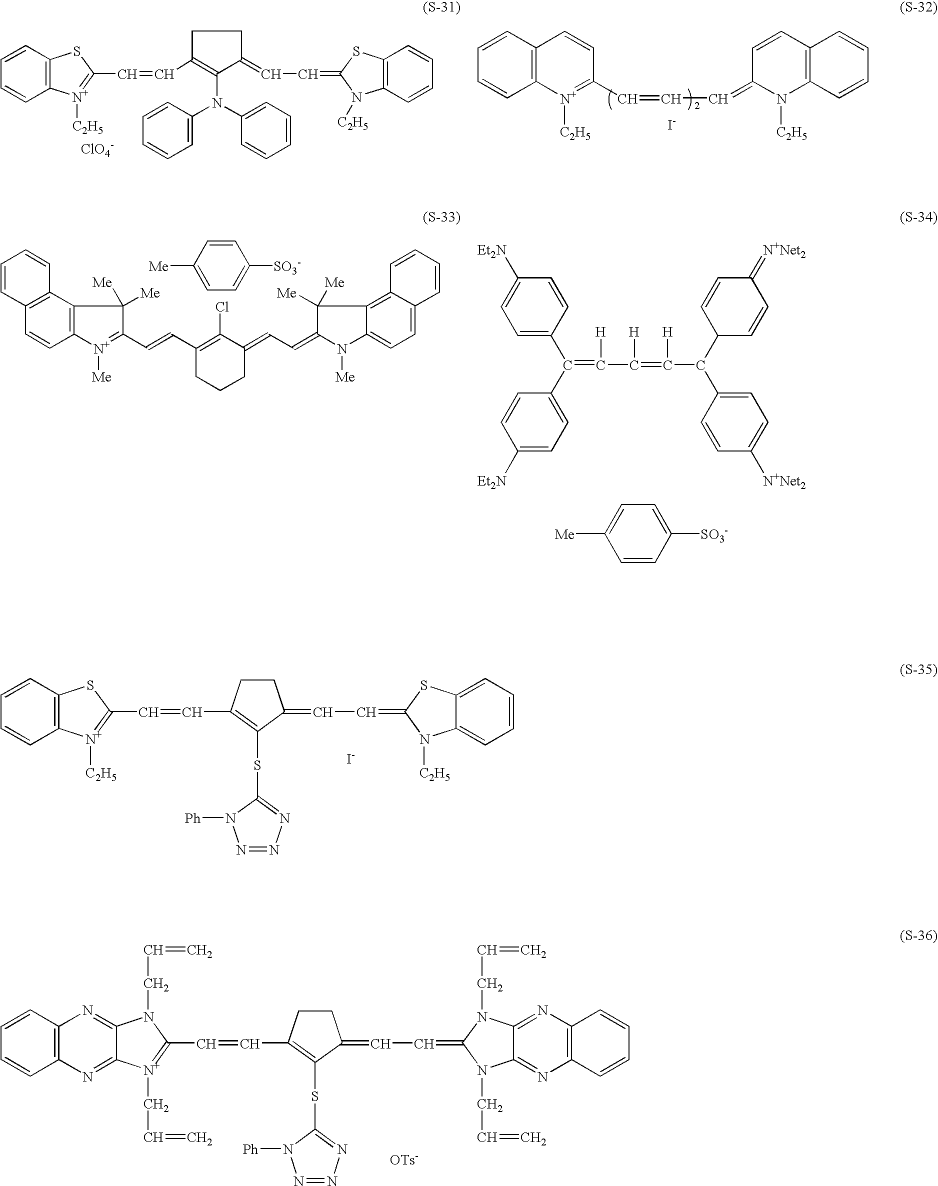

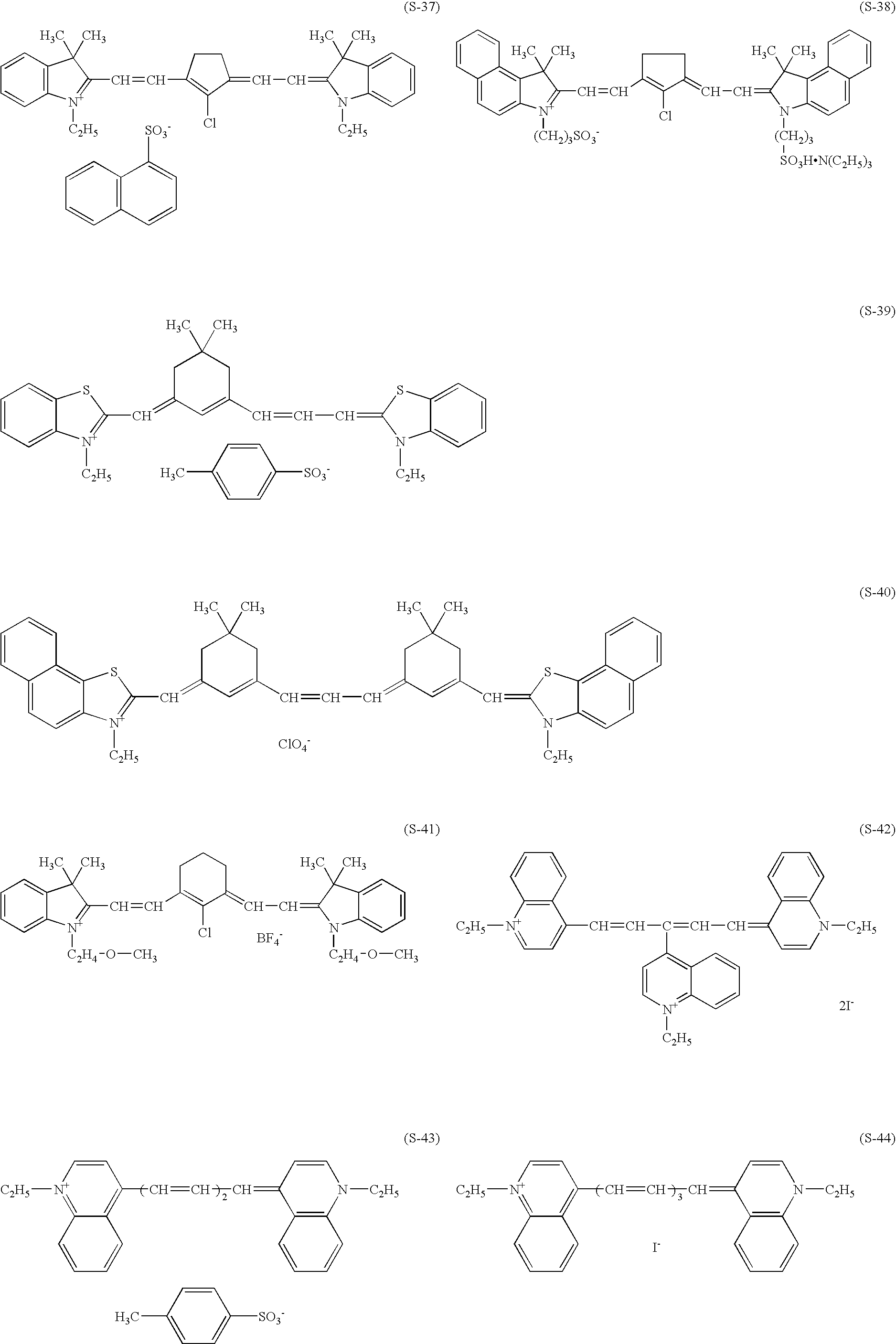

A pair anion of the exemplified sensitizing dyes as mentioned above is substituted for the above-mentioned organic boron anion can be used similarly in the present invention. An amount of the sensitizing dye is preferably 3 to 300 mg per 1 m² of the lithographic printing plate, more preferably 10 to 200 mg/m².

As the binder resin to be used in the present invention, an alkali-soluble polymer or a water-soluble polymer may be used, and an alkali-soluble polymer is particularly preferably used. The alkali-soluble polymer to be used in the present invention is a polymer which is capable of dissolving in or removable by an aqueous alkali solution, and preferably a polymer having a substituent(s) such as a hydroxyl group, a phenolic hydroxyl group, a carboxyl group, an ammonium salt group, etc. in the recurring unit constituting the polymer, particularly preferably used is a polymer having a carboxyl group.

As the above-mentioned particularly preferred alkali-soluble polymer having a carboxyl group, it is preferably various kinds of polymers comprising a copolymer, particularly preferably a polymer obtained by copolymerization of a monomer having a carboxyl group and other copolymerizable monomer. An amount of the monomer having a carboxyl group in the copolymer is preferably 5% by weight to 99% by weight. If the amount is less than the above range, the obtained copolymer tends to be not soluble in an aqueous alkali solution. The monomer containing a carboxyl group may include acrylic acid, methacrylic acid, 2-carboxyethyl acrylate, 2-carboxyethyl acrylate, crotonic acid, maleic acid, fumaric acid, monoalkyl maleate, monoalkyl fumarate, 4-carboxystyrene, etc.

As the particularly preferred alkali-soluble polymer in the present invention, a copolymer having the above-mentioned carboxyl group and having an ethylenic double bond which is capable of subjecting to radial addition at the side chain thereof is particularly preferred since it gives a light-sensitive composition with the highest sensitivity. Examples of such a polymer having a double bond at the side chain may include various polymers as disclosed in, for example, Japanese Patent Publications No. Sho.49-34041, No. Hei.6-105353 and 2000-187322. Examples of the polymers to be preferably used in the present invention are mentioned below. In the formulae, the numerals mean “% by weight” of the respective recurring units in the total copolymer composition as 100% by weight.

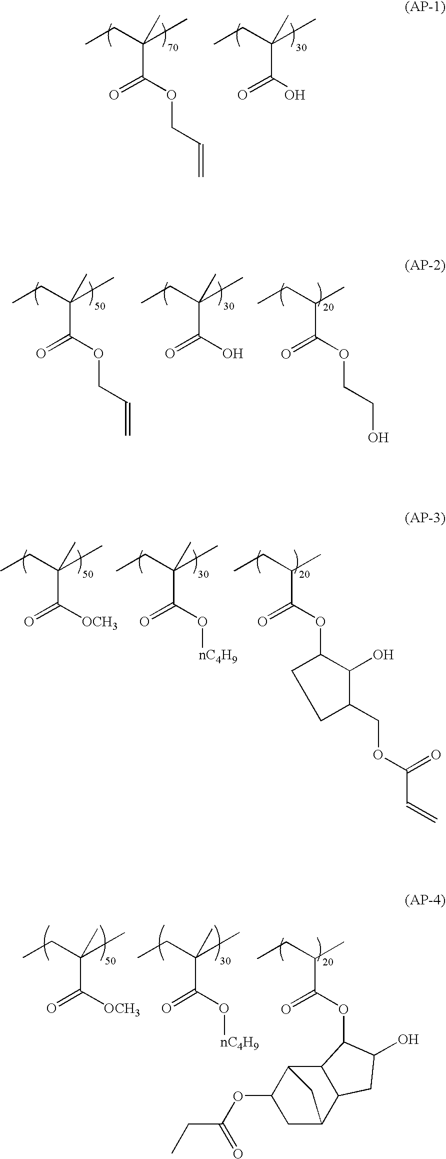

More preferred examples of the above-mentioned polymers having a double bond at the side chain may include those having a specific structure mentioned below as the double bond portion, since it gives a particularly higher sensitivity and is difficultly affected by oxygen, and no over layer to protect from oxygen is required.

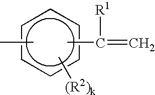

wherein R¹ represents a hydrogen atom or a methyl group, R² represents an optional atom or group other than a hydrogen atom, which is capable of substituteing, and k is an integer of 0 to 4.

The polymer having the substituent shown by the above-mentioned formula at the side chain is a polymer in which the above substituent is directly or indirectly bound through a linking group. The linking group is not specifically limited and an optional group or atom, or integrated group of the group and atom may be mentioned. A polymer having the substituent mentioned above at the side chain is more specifically a polymer having the group represented by the following formula (II) at the side chain.

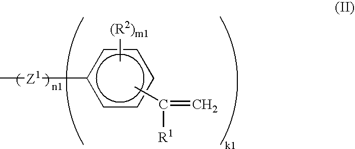

wherein Z¹ represents a linking group, n₁ is an integer of 0 or 1, m₁ is an integer of 0 to 4, k₁ is an integer of 1 to 4 and R¹ and R² have the same meanings as defined above.

The compound of the formula (II) is explained in more detail below. As the linking group of Z¹, there may be mentioned, for example, an oxygen atom, a sulfur atom, an alkylene group, an alkenylene group, an arylene group, —N(R³)—, —C(O)—O—, —C(R⁴)═N—, —C(O)—, a sulfonyl group, a heterocyclic group and a group represented by the following formula, each of which may be alone or a complex group of two or more of the above. Here, R³ and R⁴ each represent a hydrogen atom, an alkyl group or an aryl group. Moreover, with the above-mentioned linking groups, at least one of an alkyl group, an aryl group and a halogen atom may be substituted.

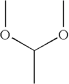

As the above-mentioned heterocyclic group, there may be mentioned, for example, a nitrogen-containing heterocyclic ring such as a pyrrole ring, a pyrazole ring, an imidazole ring, a triazole ring, a tetrazole ring, an isoxazole ring, an oxazole ring, an oxadiazole ring, an isothiazole ring, a thiazole ring, a thiadiazole ring, a thiatriazole ring, an indole ring, an indazole ring, a benzimidazole ring, a benzotriazole ring, a benzoxazole ring, a benzothiazole ring, a benzoselenazole ring, a benzothiadiazole ring, a pyridine ring, a pyridazine ring, a pyrimidine ring, a pyrazine ring, a triazine ring, a quinoline ring and a quinoxaline ring; and a furan ring and a thiophene ring; each of which may be substituted by at least one substituent.

Preferred examples of the group represented by the formula (II) are shown below, but the present invention is not limited by these.

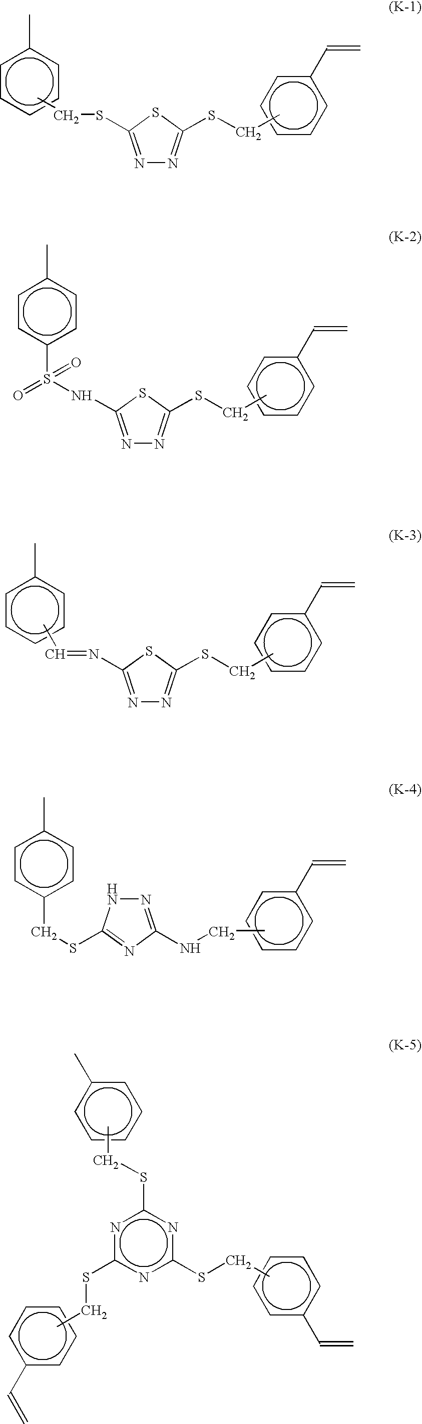

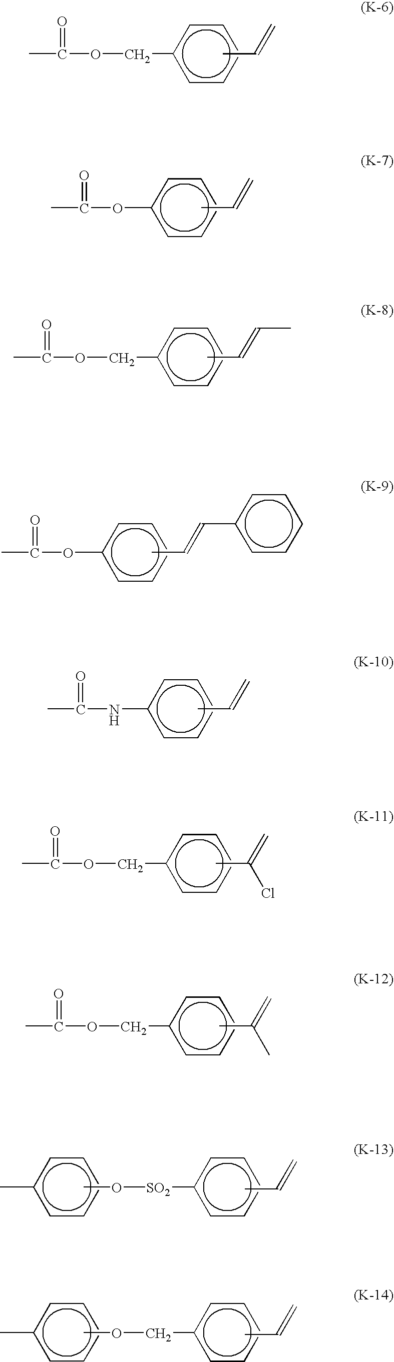

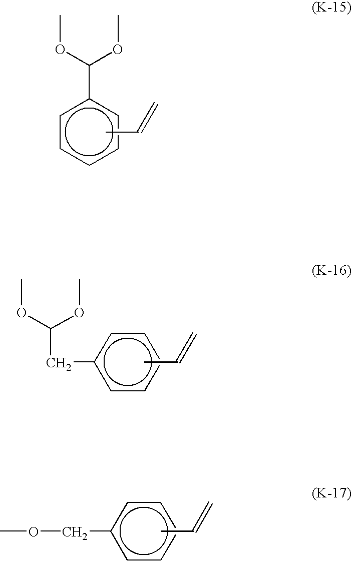

As the linking group in the above-mentioned formula (II), those containing a heterocyclic ring are preferred and those in which k₁ is 1 or 2 are also preferred.

As the polymer having the double bond shown by the above-mentioned various examples, it is preferred to have solubility in an aqueous alkaline solution, and particularly preferably a polymer containing a monomer having a carboxyl group as a copolymerizable component. In this case, as a ratio of the group represented by the formula (I) in the copolymer composition, it is preferred to be 1% by weight to 95% by weight, more preferably 5 to 80% by weight based on the total weight of the copolymer. If an amount of the group represented by the formula (I) is less than 1% by weight, the effect of incorporating the group cannot be admitted in some cases, while if it exceeds 95% by weight, the copolymer does not dissolve in an aqueous alkaline solution in some cases. Moreover, it is preferred to contain the monomer having a carboxyl group in the copolymer in an amount of 5% by weight to 99% by weight based on the total weight of the copolymer. If an amount of the monomer is less than 1% by weight, the copolymer does not dissolve in an aqueous alkaline solution in some cases.

As the monomer having a carboxyl group mentioned above, there may be exemplified by, for example, acrylic acid, methacrylic acid, 2-carboxyethyl acrylate, 2-carboxyethyl methacrylate, crotonic acid, maleic acid, fumaric acid, monoalkyl maleate, monoalkyl fumarate, 4-carboxystyrene, etc. as mentioned above.

It is also possible to prepare a copolymer by incorporating a monomer other than the monomer having a carboxyl group in the copolymer to form a multi-component copolymer. As such a monomer to be incorporated into the copolymer, there may be mentioned, for example, a styrene derivative such as styrene, 4-methylstyrene, 4-hydroxystyrene, 4-acetoxystyrene, 4-carboxystyrene, 4-aminostyrene, chloromethylstyrene, 4-methoxystyrene, etc.; alkyl methacrylate such as methyl methacrylate, ethyl methacrylate, butyl methacrylate, hexyl methacrylate, 2-ethylhexyl methacrylate, cyclohexyl methacrylate, dodecyl methacrylate, etc.; aryl methacrylate or aralkyl methacrylate such as phenyl methacrylate, benzyl methacrylate, etc.; a methacrylic acid ester having a hydroxyalkyl group such as 2-hydroxyethyl methacrylate, 2-hydroxypropyl methacrylate, etc.; a methacrylic acid ester having an alkyleneoxy group such as methacrylic acid methoxydiethylene glycol monoester, methacrylic acid methoxypolyethylene glycol monoester, methacrylic acid polypropylene glycol monoester, etc.; methacrylate having an amino group such as 2-dimethylaminoethyl methacrylate, 2-diethylaminoethyl methacrylate, etc.; or acrylates corresponding to the above-mentioned methacrylates; a monomer having a phosphate group such as vinyl phosphonic acid, etc.; a monomer having an amino group such as allyl amine, diallyl amine, etc.; a monomer having a sulfonic acid group such as vinylsulfonic acid or a salt thereof, allylsulfonic acid or a salt thereof, methallylsulfonic acid or a salt thereof, styrenesulfonic acid or a salt thereof, 2-acrylamide-2-methylpropanesulfonic acid or a salt thereof, etc.; a monomer having a nitrogen-containing heterocyclic ring such as 4-vinylpyrrolidine, 2-vinylpyrrolidine, N-vinylimidazole, N-vinylcarbazole, etc.; a monomer having a quaternary ammonium salt group such as 4-vinyl benzyltrimethyl ammonium chloride, acryloyloxyethyltrimethyl ammonium chloride, methacryloyloxyethyltrimethyl ammonium chloride, a quaternized product of dimethylaminopropyl acrylamide by methyl chloride, a quaternized product of N-vinylimidazole by methyl chloride, 4-vinylbenzylpyridinium chloride, etc.; acrylonitrile, methacrylonitrile, etc.; an acrylamide or methacrylamide derivative such as acrylamide, methacrylamide, dimethylacrylamide, diethylacrylamide, N-isopropylacrylamide, diacetoneacrylamide, N-methylolacrylamide, N-methoxyethylacrylamide, 4-hydroxyphenylacrylamide, etc.; phenylmaleimide, hydroxyphenylmaleimide; a vinyl ester such as vinyl acetate, vinyl chloroacetate, vinyl propionate, vinyl butyrate, vinyl stearate, vinyl benzoate, etc.; a vinyl ether such as methyl vinyl ether, butyl vinyl ether, etc.; and other monomers such as N-vinylpyrrolidone, acryloylmorpholine, tetrahydrofurfuryl methacrylate, vinyl chloride, vinylidene chloride, allyl alcohol, vinyl trimethoxysilane, glycidyl methacrylate, and the like. As a ratio of these monomers having no carboxyl group in the copolymer composition, they can be optionally incorporated into the composition with any ratio so long as the ratios of the group represented by the formula (I) and the monomer having a carboxyl group are maintained in preferred ranges.

The molecular weight of the above-mentioned copolymer is preferably within the range of 1,000 to 1,000,000, more preferably 10,000 to 300,000 in terms of a weight average molecular weight (Mw).

A ratio of the polymer of the present invention in the light-sensitive layer is preferably within the range of 10 parts by weight to 80 parts by weight, more preferably 20 parts by weight to 80 parts by weight based on 100 parts by weight of the total components constituting the light-sensitive layer.

Examples of the polymer having the group represented by the formula (I) according to the present invention are shown below. In the formulae, the numeral means % by weight of the respective recurring units in the copolymer based on the total weight as 100% by weight.

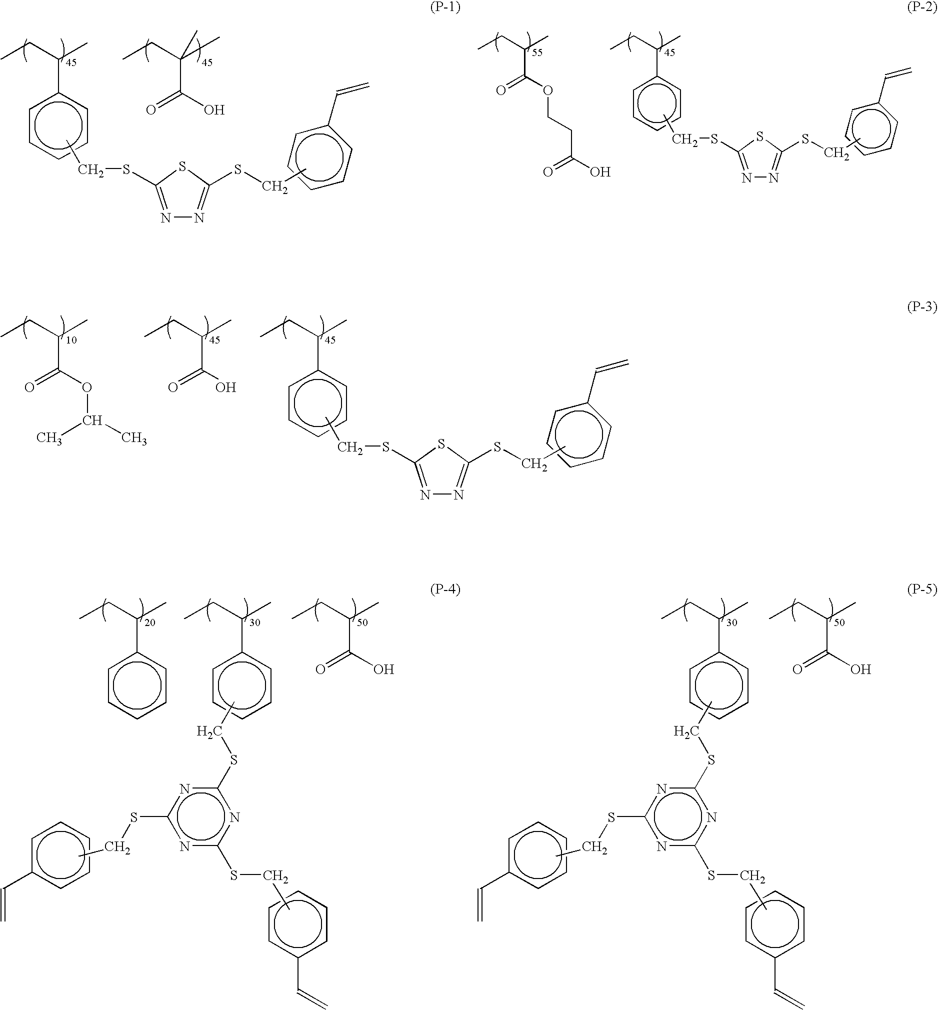

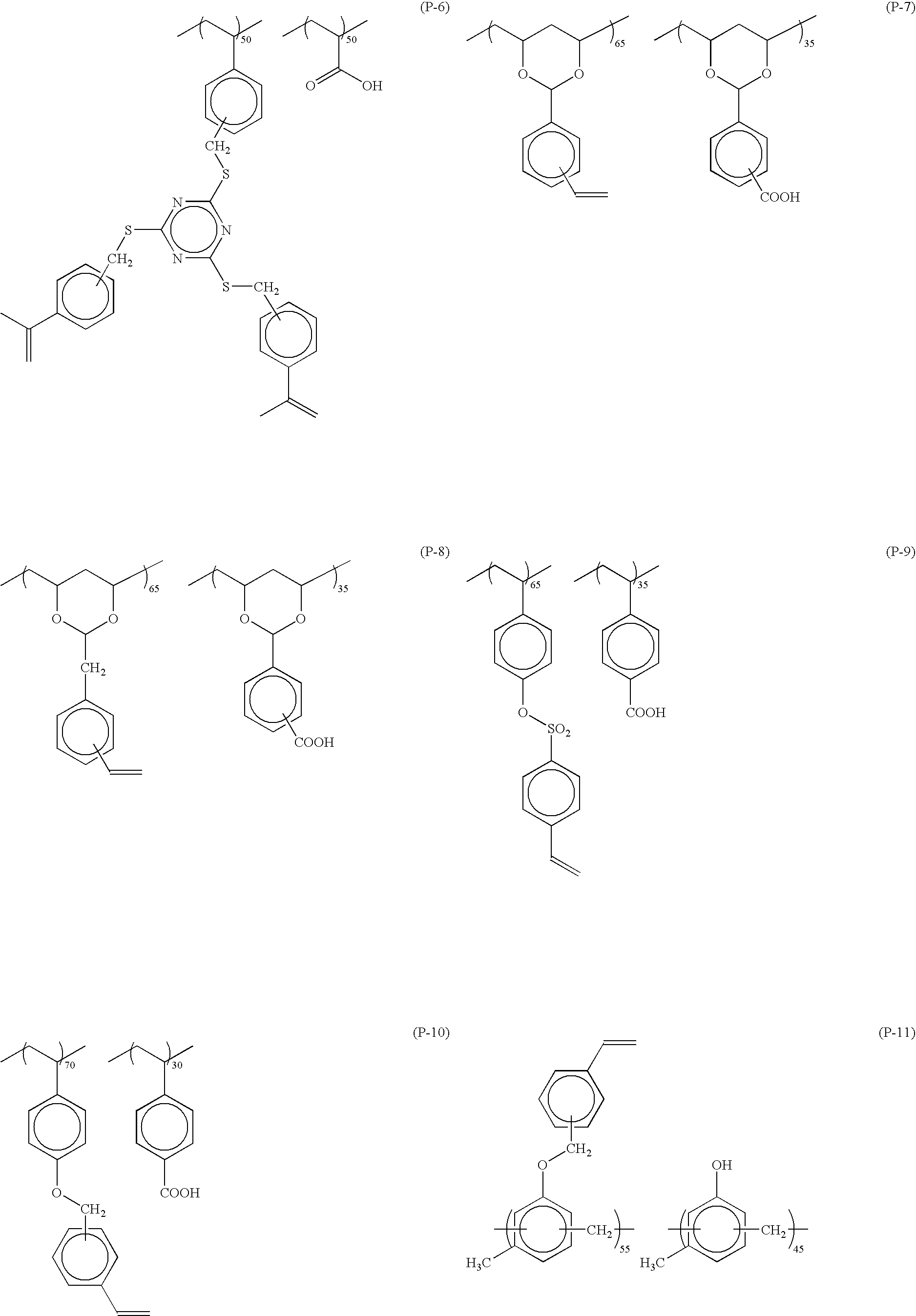

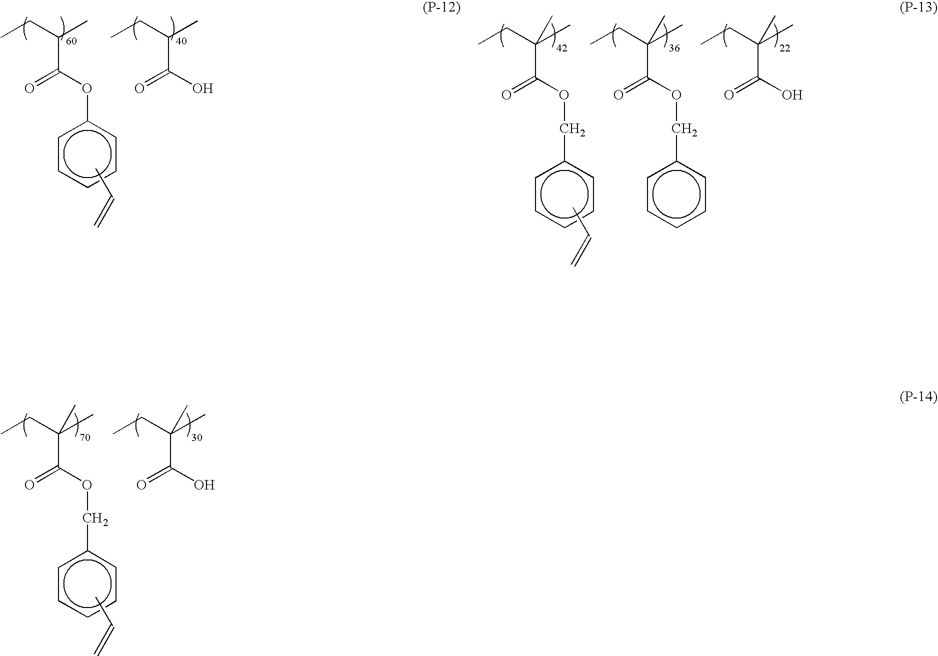

The light-sensitive composition of the present invention may preferably contain other components than those as mentioned above for the various purposes. It is particularly preferably carried out to add various kinds of polymerization inhibitors for the purpose of preventing the styryl groups from thermal polymerization or thermal cross-linking and of improving preservability for a long period of time. As the polymerization inhibitors in this case, there may be preferably used various kinds of compounds having a phenolic hydroxyl group such as hydroquinones, chatechols, naphthols, cresols, etc., or quinone compounds, particularly preferably hydroquinone. An amount of the polymerization inhibitor in this case is preferably in the range of 0.1 to 10 parts by weight based on 100 parts by weight of the polymer.

As an element(s) to constitute the lithographic printing plate, various kinds of dyes or pigments may be preferably added for the purpose of heightening recognizability with eyes of image portion, or inorganic fine particles or organic fine particles may be added for the purpose of preventing from blocking of the light-sensitive composition.

As the above-mentioned pigments, there may be mentioned, for example, a black pigment, a yellow pigment, an orange pigment, a brown pigment, a red pigment, a purple pigment, a blue pigment, a green pigment, a fluorescent pigment, a metallic powder pigment, a polymer binding dye, etc. More specifically, there may be mentioned an insoluble azo pigment, an azo lake pigment, a condensed azo pigment, a chelate azo pigment, a phthalocyanine pigment, an anthraxquinone pigment, perylene and a perylene pigment, a thioindigo type pigment, a quinacridone pigment, a dioxazine pigment, an isoindolinone pigment, a quinophthalone pigment, a dye lake pigment, an azine pigment, a nitroso pigment, a nitro pigment, a natural pigment, a fluorescent pigment, an inorganic pigment, carbon black, etc.

These pigments may be used without carrying out the surface treatment, or may be used after carrying out the surface treatment. In the surface treatment method, there may be mentioned a method in which a resin or wax is subjected to surface coating, a method of adhering a surfactant, a method of binding a reactive substance (for example, a silane coupling agent, an epoxy compound, polyisocyanate, etc.) onto the surface of the pigment, and the like. The above-mentioned surface treatment methods are described in “Characteristics and Application of Metallic Soap” (published by Saiwai Shobo, Japan), “Printing Ink Technology” (published by CMC Publishing, 1984, Japan), and “Latest Pigment Application Technology (published by CMC Publishing, 1986, Japan).

A particle size of the above-mentioned pigment is preferably in the range of 0.01 to 10 μm, more preferably 0.05 to 1 μm, particularly preferably 0.1 to 1 μm. If the particle size of the pigment is less than 0.01 μm, it is not preferred in the point of stability of the dispersed materials in the coating solution for the light-sensitive layer, while if it exceeds 10 μm, it is not preferred in the point of uniformity of the light-sensitive layer.

As a method for dispersing the above-mentioned pigments, conventionally known dispersing techniques used for ink production or toner production may be used. As a dispersing machine, there may be mentioned, for example, an ultrasonic wave dispersing machine, a sand mill, an attritor, a pearl mill, a super mill, an inpellar, a disperser, a KD mill, a colloid mill, a dynatron, a three-roll mill, a pressure kneader, etc. Details are described in “Latest Pigment Application Technology (published by CMC Publishing, 1986, Japan).

A thickness of the light-sensitive layer itself to be used as a lithographic printing plate is preferably in the range of 0.5 μm to 10 μm with a dried thickness on the support, extremely preferably in the range of 1 μm to 5 μm for the purpose of markedly improving printing endurance. The light-sensitive layer may be provided on the support by using a conventionally known coating system, and dried.

For using a material having the light-sensitive layer formed on the support as mentioned above as a printing plate, a laser-beam scanning exposure is preferably carried out. By this exposure, the exposed portion is cross-linked so that its solubility to an alkali developer is lowered, and the non-exposed portion is dissolved out by the alkali developer to form a pattern.

The alkali developer to be used in the present invention preferably has a pH at 25° C. of 10 or more, particularly preferably in the range of 10 to 12. As an alkaline compound to make the pH of the developer in the above-mentioned range, there may be mentioned an alkaline compound such as sodium hydroxide, potassium hydroxide, sodium silicate, potassium silicate, sodium metasilicate, potassium metasilicate, monoethanolamine, diethanolamine, triethanolamine, triethylammonium hydroxide, etc., particularly preferably alkanolamine, which are used as an aqueous developer. Moreover, various kinds of alcohols such as ethanol, propanol, isopropanol, ethylene glycol, diethylene glycol, triethylene glycol, glycerin, benzyl alcohol, etc., may be preferably added to the alkali developer. Also, various kinds of surfactants are also preferably added to the same. After subjecting to development treatment using the alkali developer, usual finishing treatment is preferably carried out by using Gum Arabic, dextrins, etc.

### EXAMPLES

In the following, the present invention is explained in more detail by referring to Examples, but the present invention is not limited by these Examples.

### Example 1

A melted bath was prepared by using an aluminum alloy containing 0.06% by weight of Si, 0.30% by weight of Fe, 0.005% by weight of Cu, 0.001% by weight of Mn, 0.001% by weight of Mg, 0.001% by weight of Zn, 0.03% by weight of Ti, and the remainder being Al and inevitable impurities. After subjecting to melt bath treatment and filtration, a cast block with a thickness of 500 mm and a width of 1200 mm was prepared by the DC cast method. The surface thereof was removed with an average thickness of 10 mm by a surface cutting machine, the material was maintained at 550° C. for about 5 hours with uniform heating, and after cooling to a temperature of 400° C., it was hot rolled by using a hot rolling machine to prepare a pressed plate with a thickness of 2.5 mm. Moreover, by using a continuous annealing machine, thermal treatment was carried out at 500° C., and the plate was finished by a cold rolling to prepare an aluminum plate with a thickness of 0.24 mm. The width of the aluminum plate was made 1030 mm, and then, the following surface treatments were carried out successively.

Alkali etching treatment: The aluminum plate obtained as mentioned above was subjected to etching treatment by spraying a liquid containing 2.6% by weight of sodium hydroxide, 6.5% by weight of aluminum ion concentration with a temperature of 70° C. to dissolve the aluminum plate with an amount of 6 g/m². Thereafter, washing with water was carried out by spraying.

Desmut treatment: Desmut treatment was carried out by spraying a 1% by weight aqueous nitric acid solution (containing 0.5% by weight of aluminum ion) with a temperature of 30° C., and then, washing with water was carried out by spraying. The nitric acid aqueous solution used for the above desmutting was a disposed liquor at the step of subjecting to electrochemical surface roughening treatment by using an alternating current in a nitric acid aqueous solution.

Electrochemical surface roughening treatment: Electrochemical surface roughening treatment was carried out continuously by using an alternating current with 60 Hz. The electrolyte used at this time comprised 10.5 g/liter nitric acid aqueous solution (containing 0.5% by weight of aluminum ion) with a temperature of 50° C. The electrochemical surface roughening treatment was carried out under the conditions that a time TP in which a current value reaches from zero to a peak in an alternating current power source wave shape of 0.8 msec, a DUTY ratio of 1:1, by using a trapezoidal rectangular wave alternating current and a carbon electrode as an opposite electrode. Ferrite was used as an auxiliary anode. Two electrolysis baths were used. A current density was 30 A/dm² at the peak value of the current, and an electric amount was 220 C/dm² with the sum of the electric amount when the aluminum plate was an anode. To the auxiliary anode, 5% of the current flown from the power source was shunt. Thereafter, washing with water was carried out by spraying.

Alkali etching treatment: The aluminum plate was subjected to etching treatment by spraying a liquid containing 26% by weight of sodium hydroxide, 6.5% by weight of aluminum ion concentration with a temperature of 32° C. to dissolve the aluminum plate with an amount of 0.20 g/m² whereby smut components mainly comprising aluminum hydroxide formed at the above-mentioned electrochemical surface roughening treatment by using the alternating current were removed and an edge portion was smoothened by dissolving edge portions of the formed pits. Thereafter, washing with water was carried out by spraying.

Desmut treatment: Desmut treatment was carried out by spraying a 25% by weight aqueous sulfuric acid solution (containing 0.5% by weight of aluminum ion) with a temperature of 60° C., and then, washing with water was carried out by spraying.

Anodization treatment: Anodization treatment was carried out by using an anodization device with a two-step feeding electrolysis method (lengths at the first and the second electrolysis portions were each 6 m, lengths at the first and the second feeding portions were each 3 m, and lengths at the first and the second electrode portions were each 2.4 m). Sulfuric acid was used as electrolytes supplied to the first and the second electrolysis portions. The electrolytes were each sulfuric acid concentration of 50 g/liter (containing 0.5% by weight of aluminum ion) with a temperature of 20° C. Thereafter, washing with water was carried out by spraying. An amount of the final oxidation film was 2.7 g/m².

By using the treating liquid with the compositions shown in the following Table 1, the treatment was carried out under the temperature and time shown in Table 1. As an aqueous potassium silicate solution, an aqueous potassium silicate solution available from Tama Chemicals Co., Ltd. was used. An amount of SiO₂ contained therein was 20% by weight and those containing 10% by weight of KOH was also used in combination. By adding the aqueous potassium silicate solution and KOH, the ratio of SiO₂/K₂O was set as shown in Table 1.

TABLE 1

| | KOH | SiO₂ | | Processing | Processing |
|---|---|---|---|---|---|
| Samples | (%) | (%) | SiO₂/K₂O | temperature | time |
| Comparative | 0.3 | 0.02 | 0.1 | 60° C. | 10 sec. |
| example 1 | | | | | |
| Comparative | 2.0 | 4.2 | 0.3 | 60° C. | 10 sec. |
| example 2 | | | | | |
| Comparative | 7.0 | 0.8 | 4.7 | 60° C. | 10 sec. |
| example 3 | | | | | |
| Comparative | 2.0 | 1.2 | 0.9 | 45° C. | 10 sec. |
| example 4 | | | | | |
| Comparative | 2.0 | 1.2 | 0.9 | 75° C. | 10 sec. |
| example 5 | | | | | |
| Present | 0.7 | 1.2 | 0.4 | 60° C. | 10 sec. |
| invention 1 | | | | | |
| Present | 1.0 | 1.2 | 0.5 | 60° C. | 10 sec. |
| invention 2 | | | | | |
| Present | 4.0 | 2.6 | 1.2 | 60° C. | 10 sec. |
| invention 3 | | | | | |
| Present | 2.0 | 1.2 | 0.9 | 60° C. | 10 sec. |
| invention 4 | | | | | |
| Present | 2.0 | 1.2 | 0.9 | 60° C. | 5 sec. |
| invention 5 | | | | | |
| Present | 2.0 | 1.2 | 0.9 | 55° C. | 10 sec. |
| invention 6 | | | | | |
| Present | 2.0 | 1.2 | 0.9 | 65° C. | 10 sec. |
| invention 7 | | | | | |
| Present | 3.0 | 3.8 | 0.4 | 60° C. | 10 sec. |
| invention 8 | | | | | |

On the aluminum support prepared as mentioned above was applied by coating a light-sensitive coating solution shown by the following prescription with a dry thickness of 2.0 μm and drying was carried out in a drying oven at 75° C. for 6 minutes.

<Light-sensitive coating solution>

| | |
|---|---|
| Photoradical generator (BC-6) | 1 part |
| Trihalo-substituted alkyl compound (T-4) | 0.5 part |
| Binder resin (P-1) | 11 parts |
| Sensitizing dye (S-34) | 0.5 part |
| Dioxane | 70 parts |
| Cyclohexane | 20 parts |

The lithographic printing plate material prepared as mentioned above was subjected to exposure by using an output machine, Imagesetter PT-R4000 (trade name) manufactured by Dainippon Screen MFG Co., Ltd. (oscillation wavelength: 830 nm, Output power: 100 mW) and treated by Developer 1 with the following prescription at 300 for 30 seconds, and successively the gum liquid with the following prescription was coated thereon.

<Developer 1>

| | |
|---|---|
| KOH | 30 g |
| 20% potassium silicate aqueous solution | 25 g |
| (containing 20% of SiO₂) | |
| Emulgen MS110 (available from KAO) | 0.1 g |

Made up to 1 liter with water and a pH was adjusted to 13.5 (25° C.).

<Gum liquid>

| | |
|---|---|
| Monopotassium phosphate | 20 g |
| Gum Arabic | 30 g |
| Sodium dehydroacetate | 0.5 g |
| EDTA 2Na (disodium ethylenediamine tetraacetate) | 1 g |

Made up to 1 liter with water.

Characteristics of the printing plate prepared as mentioned above were evaluated. Printing was carried out by using a printing machine, Heidelberg KORD (trade name, an offset printing machine manufactured by Heiderberg Co.), ink (New Champion Black H, trade name, available from Dainippon Ink Co., Japan) and a commercially available dampening solution for a PS plate (Astromark III, trade name available from Nikken Chemicals Co., Ltd.) until 200,000 sheets, and printing endurance was evaluated. The printing endurance was evaluated by the number of printed sheets until either ink adhesion at the image portion became poor or fine line was disappeared. The results are shown in Table 2

Printing stain was carried out as shown below. Printing was carried out by using a printing machine, Heidelberg KORD (trade name, an offset printing machine manufactured by Heiderberg Co.), ink (HYECOO Magenta (M), trade name, available from Dainippon Ink Co., Japan) and a commercially available dampening solution for a PS plate (Astromark III, trade name available from Nikken Chemicals Co., Ltd.) until 200,000 sheets, and accumulated state of the ink at the non-image portion on the blanket and the state of the printed material were evaluated with naked eyes with the following standard.

∘: No stain occurred on the blanket.

Δ: Accumulation of ink was observed on the blanket but no stain occurred on the printed materials.

X: Stain occurred on the printed materials.

TABLE 2

| | Printing | |
|---|---|---|
| Samples | endurance | Stain |
| Comparative | 30,000 | X |
| example 1 | | |
| Comparative | 50,000 | Δ |
| example 2 | | |
| Comparative | 20,000 | Δ |
| example 3 | | |
| Comparative | 30,000 | ◯◯ |
| example 4 | | |
| Comparative | 200,000 | X |
| example 5 | | |
| Present | 200,000 | ◯ |
| invention 1 | | |
| Present | 190,000 | ◯ |
| invention 2 | | |
| Present | 170,000 | ◯ |
| invention 3 | | |
| Present | 200,000 | ◯ |
| invention 4 | | |
| Present | 200,000 | ◯ |
| invention 5 | | |
| Present | 200,000 | ◯ |
| invention 6 | | |
| Present | 200,000 | ◯ |
| invention 7 | | |
| Present | 200,000 | ◯ |
| invention 8 | | |

As can be seen from the results shown in Table 2, in the printing plates of Comparative examples, a number of sheets with good quality was each 100,000 sheets or less or printing stain occurred, so that they were insufficient as a printing plate. On the other hand, in the printing plates of the present invention, it can be understood that they have printing endurance of 150,000 sheets or more and no stain occurred.

### Example 2

In this example, a pH of the developer was investigated. The printing plates of Comparative examples 1 to 5 and Present inventions 1 to 8 prepared in the same manner as in Example 1 were subjected to exposure in the same manner as in Example 1. Then, to the processor used in Example 1, Developer 2 with the prescription shown below and the gum liquid used in Example 1 were introduced, and plate making treatment was carried out under the development conditions at 30° C. for 20 seconds, and the gum liquid was coated thereon.

<Developer 2>

| | |
|---|---|
| N-methylethanolamine | 30 g |
| Pelex NBL (available from KAO) | 50 g |
| Phosphoric acid | 10 g |
| 48% KOH | 50 g |

Made up to 1 liter with water.

A pH of the developer was adjusted to 11.5 (25° C.). Here, Pelex NBL is an aqueous solution of an alkylnaphthalene sulfonic acid type surfactant.

The thus prepared printing plates were evaluated by carrying out the printing test in the same manner as in Example 1. The results are shown in Table 3.

TABLE 3

| | | | Non-image portion of |
|---|---|---|---|
| | Printing | | printing surface at |
| Samples | endurance | Stain | printing |
| Comparative | 100,000 | X | Residual film |
| example 1 | | | generated |
| Comparative | 120,000 | X | |
| example 2 | | | |
| Comparative | 140,000 | X | |
| example 3 | | | |
| Comparative | 100,000 | X | |
| example 4 | | | |
| Comparative | 200,000 | X | Residual film |
| example 5 | | | generated |
| Present | 200,000 or | ◯ | |
| invention 1 | more | | |
| Present | 200,000 or | ◯ | |
| invention 2 | more | | |
| Present | 200,000 or | ◯ | |
| invention 3 | more | | |
| Present | 200,000 or | ◯ | |
| invention 4 | more | | |
| Present | 200,000 or | ◯ | |
| invention 5 | more | | |
| Present | 200,000 or | ◯ | |
| invention 6 | more | | |
| Present | 200,000 or | ◯ | |
| invention 7 | more | | |
| Present | 200,000 or | ◯ | |
| invention 8 | more | | |

As can be seen from the results shown in Table 3, in Comparative examples 1 to 5, evaluations for the printing endurance were better than those of Example 1 shown in Table 2, but stain occurred at the non-image portion of the printed materials. In particular, in Comparative examples 1 and 5, residual film occurred at the non-image portion and the light-sensitive layer cannot completely be removed from the surface of the lithographic printing plate. On the other hand, in the printing plates of the present invention, it can be understood that they have printing endurance of 200,000 sheets or more and no stain on the printed material and on the blanket occurred.

1. A process for preparing a light-sensitive lithographic printing plate using an aluminum plate as a support and having a light-sensitive layer provided on the support, which comprises subjecting the aluminum support after anodization treatment to a treatment in an alkali silicate with a concentration of SiO₂ of 1 to 4% by weight, a concentration of an alkali metal hydroxide of 0.5 to 5% by weight and a molar ratio of SiO₂/M₂O where M represents an alkali metal being in the range of 0.3 to 1.5 at 50 to 70° C. for 20 seconds or shorter.

2. The process for preparing a light-sensitive lithographic printing plate according to claim 1, wherein the alkali metal is potassium.

3. The process for preparing a light-sensitive lithographic printing plate according to claim 1, wherein the light-sensitive layer is a photopolymerizable layer containing at least a polymer which comprises a monomer having a polymerizable double bond at a side chain and a carboxyl group, and an organic boron salt.

4. The process for preparing a light-sensitive lithographic printing plate according to claim 1, wherein the photopolymerizable layer further contains an ethylenically unsaturated compound.

5. The process for preparing a light-sensitive lithographic printing plate according to claim 3, wherein the photopolymerizable layer further contains a sensitizing dye.

6. The process for preparing a light-sensitive lithographic printing plate according to claim 4, wherein the photopolymerizable layer further contains a sensitizing dye.

7. A method for processing a light-sensitive lithographic printing plate according to claim 1, which comprises subjecting the lithographic printing plate after image exposure to development with an aqueous developer having a pH of 10 to 12.

8. A method for processing a light-sensitive lithographic printing plate according to claim 2, which comprises subjecting the lithographic printing plate after image exposure to development with an aqueous developer having a pH of 10 to 12.

9. A method for processing a light-sensitive lithographic printing plate according to claim 3, which comprises subjecting the lithographic printing plate after image exposure to development with an aqueous developer having a pH of 10 to 12.

10. A method for processing a light-sensitive lithographic printing plate according to claim 4, which comprises subjecting the lithographic printing plate after image exposure to development with an aqueous developer having a pH of 10 to 12.

11. A method for processing a light-sensitive lithographic printing plate according to claim 5, which comprises subjecting the lithographic printing plate after image exposure to development with an aqueous developer having a pH of 10 to 12.

12. A method for processing a light-sensitive lithographic printing plate according to claim 6, which comprises subjecting the lithographic printing plate after image exposure to development with an aqueous developer having a pH of 10 to 12.

13. The method for processing a light-sensitive lithographic printing plate according to claim 7, wherein the image exposure is carried out by laser exposure.

14. The method for processing a light-sensitive lithographic printing plate according to claim 8, wherein the image exposure is carried out by laser exposure.

15. The method for processing a light-sensitive lithographic printing plate according to claim 9, wherein the image exposure is carried out by laser exposure.

16. The method for processing a light-sensitive lithographic printing plate according to claim 10, wherein the image exposure is carried out by laser exposure.

17. The method for processing a light-sensitive lithographic printing plate according to claim 11, wherein the image exposure is carried out by laser exposure.

18. The method for processing a light-sensitive lithographic printing plate according to claim 12, wherein the image exposure is carried out by laser exposure.
